(19) United States
(12) Patent Application Publication
(10) Pub. No.: US 2011/0183549 A1
(43) Pub. Date: Jul. 28, 2011

(54) ELECTRICAL CONNECTOR PROVIDING SELF-ADJUSTING CONTACTS FOR RELEASING STRAIN

(75) Inventor: JING-JIE GUO, Shenzhen (CN)

(73) Assignee: HON HAI PRECISION INDUSTRY CO., LTD., New Taipei (TW)

(21) Appl. No.: 13/013,854

(22) Filed: Jan. 26, 2011

(30) Foreign Application Priority Data
Jan. 28, 2010 (CN) 201020301786.8

(51) Int. Cl. H01R 24/00

(52) U.S. Cl. 439/676

(57) ABSTRACT

An electrical connector includes an insulative housing (1) defining a number of passageways (111) and a mating direction, a plurality of contacts (2) received in the insulative housing, and a printed circuit board (5). The contacts include a number of contacting portions (21) received in and extending beyond the passageways, a number of soldering portions (22) extending out of the insulative housing in two parallel planes, and a number of linking portions (23, 24) between the contacting portions and the soldering portions. The printed circuit board is sandwiched by the soldering portions. Each linking portion defines a notch (241) adjacent to the corresponding soldering portion. The linking portion has a number of bending portions (24) alternately extending upwardly and downwardly in a vertical direction perpendicular to the mating direction and the notches are defined on the bending portions.

### BACKGROUND OF THE INVENTION

1. Field of the Invention

The present invention relates generally to an electrical connector, and more particularly to an electrical connector providing self-adjusting contacts for releasing strain during insertion of a mating connector.

2. Description of Related Arts

Normally, a USB connector comprises an insulative housing, a plurality of contacts assembled in the insulative housing, and a shield covering the insulative housing. The contacts have a plurality of soldering portions assembled onto a printed circuit board and a plurality of contacting portions engaging a mating connector for transmitting signals therebetween. Because the contacts have tolerance in the manufacturing process, the contacting portions and the soldering portions may not both achieve individual coplanairty after assembling the contacts into the insulative housing. Coplanarity of the soldering portions of the contacts is a main concerned subject in the art. While the soldering portions are to be soldered on the printed circuit board and assumed coplanar after soldering, the contacting portions of the contacts are most likely not coplanar. When the mating connector is inserted, the contacting portions are forced to be coplanar, causing strain to some soldering portions and even damage to connection between the soldering portions and the printed circuit board.

Hence, an electrical connector providing self-adjusting contacts for releasing strain during insertion of a mating connector is desired.

### SUMMARY OF THE INVENTION

Accordingly, an object of the present invention is to provide an electrical connector providing self-adjusting contacts for releasing strain during insertion of a mating connector.

To achieve the above object, an electrical connector includes an insulative housing defining a number of passageways and a mating direction, a plurality of contacts received in the insulative housing, and a printed circuit board. The contacts include a number of contacting portions received in and extending beyond the passageways, a number of soldering portions extending out of the insulative housing in two parallel planes, and a number of linking portions between the contacting portions and the soldering portions. The printed circuit board is sandwiched by the soldering portions. Each linking portion defines a notch adjacent to the corresponding soldering portion. The linking portion has a number of bending portions alternately extending upwardly and downwardly in a vertical direction perpendicular to the mating direction and the notches are defined on the bending portions.

Other objects, advantages and novel features of the invention will become more apparent from the following detailed description when taken in conjunction with the accompanying drawings.

### BRIEF DESCRIPTION OF THE DRAWINGS

FIG. 1 is a perspective, assembled view of an electrical connector constructed in accordance with the present invention, and wherein a printed circuit board is shown;

FIG. 2 is a rear elevational view of FIG. 1;

FIG. 3 is a perspective, fully exploded view of FIG. 1; and

FIG. 4 is a rear elevational view of the insulative housing.

### DETAILED DESCRIPTION OF THE PREFERRED EMBODIMENT

Reference will now be made in detail to the preferred embodiment of the present invention.

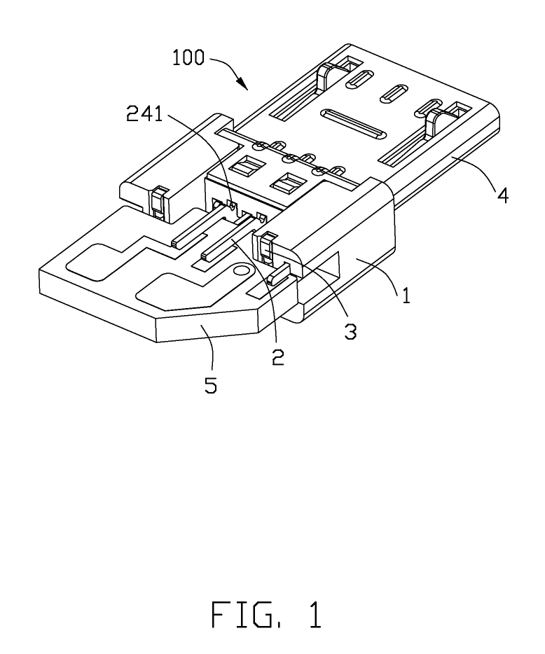

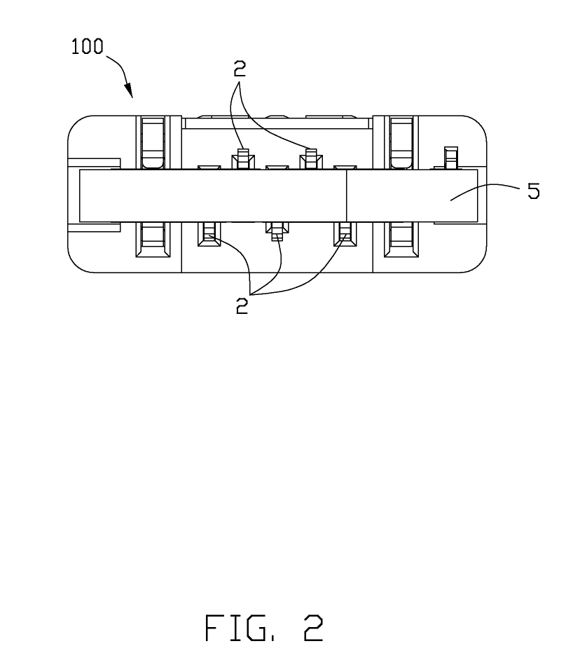

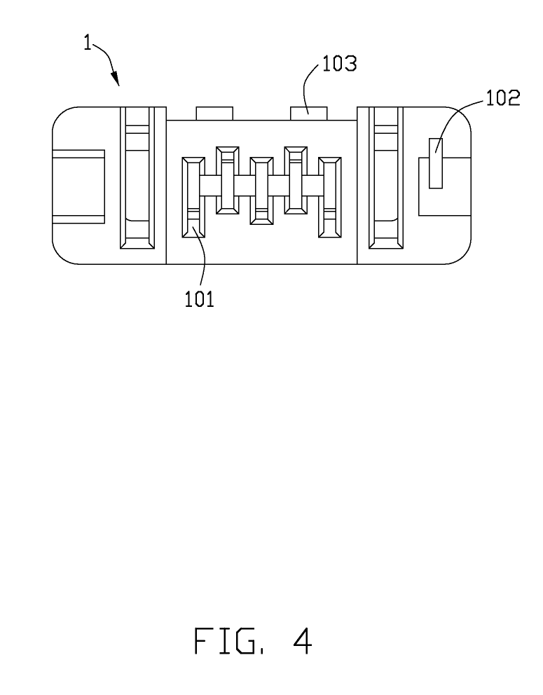

Referring to FIGS. 1-4, an electrical connector 100 in accordance with the present invention, used for receiving a mating connector (not shown) along a mating direction, comprises an insulative housing 1, a plurality of contacts 2 assembled in the insulative housing 1, a pair of latches 3 assembled in the insulative housing 1, too, and a metallic shell 4 covering the insulative housing 1. A printed circuit board 5 is sandwiched by the contacts 2 and a plurality of cable wires (not shown) is connected to the printed circuit board 5 for electrical connection.

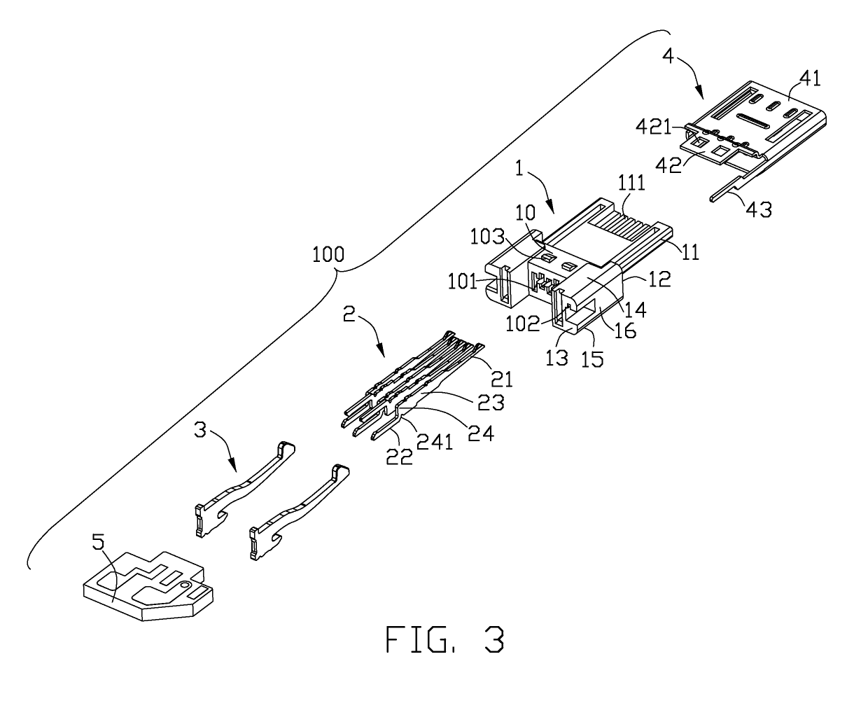

Referring to FIG. 3, the insulative housing 1 comprises a base portion 10 and a tongue portion 11 extending forwardly from the base portion 10. The base portion 10 defines a front face 12, a rear face 13 opposite to the front face 12, a top face 14, a bottom face 15 opposite to the top face 14, and a pair of lateral faces 16. The tongue portion 11 extends from the front face 12 of the base portion 10. The tongue portion 11 is located above the bottom face 15 and below the top face 14, i.e., the tongue portion 11 has a height smaller than that of the base portion 10. The tongue portion 11 defines a plurality of passageways 111 extending along the mating direction. The base portion 10 defines a plurality of apertures 101 communicating with the passageways 111. The apertures 101 extend from the front face 12 and ends at the rear face 13 such that the contacts 2 are received in the passageways 111 and extend out of the insulative housing 1 from the rear face 13 through the apertures 101. The apertures 101 are alternately offset in a vertical direction perpendicular to the mating direction. The insulative housing 1 further defines a slit 102 at a lateral side of the apertures 101. The insulative housing 1 forms a pair of protrusions 102 on the top face 103.

Referring to FIG. 3, the contacts 2 have a plurality of contacting portions 21 received in the passageways 111, a plurality of soldering portions 22 extending out of the insulative housing 1, and a plurality of linking portions (not labeled) between the contacting portions 21 and the soldering portions 22. The linking portions comprise a plurality of retaining portions 23 retained in the base portion 10, and a plurality of bending portions 24 alternately extending upwardly and downwardly from the retaining portions 23. The contacting portions 21 extend beyond the tongue portion 11 for connecting with the mating connector. The soldering portions 22 are located at two parallel planes such that the soldering portions 22 sandwich the printed circuit board 5. Each bending portion 24 defines a notch 241 adjacent to the corresponding soldering portion 22. Each contact 2 extends in a vertical plane, the contacting portions 21 are arranged in a first horizontal plane perpendicular to the vertical plane, and the soldering portions 22 are arranged in two different horizontal planes, with one above the first horizontal plane and the other below the first horizontal plane.

Referring to FIGS. 1 and 3, the metallic shell 3 comprises a casing portion 41 and a sleeve portion 42 extending upwardly, rearward from an upper edge of the casing portion 41. The casing portion 41 shields over the tongue portion 11 of the insulative housing 1. The sleeve portion 42 is attached to the top face 104 of the base portion 10. The sleeve portion 42 defines a pair of cutouts 421 correspondingly retaining the protrusions 103 of the base portion 10 for fixing the metallic shell 3 on the insulative housing 1. The casing portion 41 laterally forms a shaft 43 extending rearward therefrom as the sleeve portion 42. The shaft 43 extends through the slit 102 and contacts a grounding pad (not labeled) of the printed circuit board 5.

Referring to FIGS. 1-4, when the printed circuit board 5 is inserted between the soldering portions 22, the soldering portions 22 are slightly, outwardly deformed, and strain provided by the printed circuit board 5 is released by the notches 241 of the bending portions 24. Because the soldering portions 22 define an interspace smaller than a thickness of the printed circuit board 5, the printed circuit board 5 is securely sandwiched by the soldering portions 22. In a preferred embodiment, the soldering portions 22 are soldered on the printed circuit board 5. When the mating connector is inserted along the mating direction, pressure to the contacting portions 21 by the mating connector likely causes strain to the soldering portion 22. However, the strain is released due to the notches 241 of the bending portions 24. Therefore, the soldering portions 22 are prevented from being damaged for the strain has been released already. In a preferred embodiment, the notches 241 is formed adjacent the rear face 13 of the base portion 10. The notches 241 are exposed out of the insulative housing 1 for more conveniently releasing strain thereof.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. An electrical connector assembly comprising:
an insulative housing defining a plurality of passageways and a mating direction;
a plurality of contacts received in the insulative housing, the contacts comprising a plurality of contacting portions received in and extending beyond the passageways, a plurality of soldering portions extending out of the insulative housing in two parallel planes, and a plurality of linking portions between the contacting portions and the soldering portions, each linking portion defining a notch adjacent to the corresponding soldering portion; and
a printed circuit board sandwiched by the soldering portions; wherein
the linking portion has a plurality of bending portions alternately extending upwardly and downwardly in a vertical direction perpendicular to the mating direction and the notches are defined in the bending portions.

2. The electrical connector assembly as claimed in claim 1, wherein the notches are exposed out of the insulative housing.

3. The electrical connector assembly as claimed in claim 1, wherein the notches are located at two opposite sides of the printed circuit board.

4. The electrical connector assembly as claimed in claim 1, further comprising a metallic shell covering the insulative housing.

5. The electrical connector assembly as claimed in claim 4, wherein the insulative housing comprises a tongue portion and the metallic shell comprises a casing portion shielding over the tongue portion.

6. The electrical connector assembly as claimed in claim 5, wherein the insulative housing comprises a base portion extending reward from the tongue portion, and the metallic shell comprises a sleeve portion attached to the sleeve portion.

7. The electrical connector assembly as claimed in claim 6, wherein the metallic shell comprises a shaft, the insulative housing defines a slit on the base portion, and the shaft extends through the slit to contact the printed circuit board.

8. An electrical connector assembly comprising:
an insulative housing defining a base portion with a tongue portion forwardly extending therefrom and spanning in a transverse direction with a mating face thereon above which a mating port is formed;
a plurality of passageways disposed in the housing and extending in a front-to-back direction perpendicular to said transverse direction;
a first set of contacts disposed in the housing, each of said contacts stamped from sheet metal and lying in a vertical plane perpendicular to said transverse direction, and
each of said contacts further defining a retention section retained within the corresponding passageway, a contacting section extending forwardly from the retention section with a contacting apex protruding out of the mating face in a first vertical direction perpendicular to both said transverse direction and said front-to-back direction, and into the mating port, and a tail section extending rearwardly from the retention section in the front-to-back direction and defining a board mounting face facing in a second vertical direction opposite to said first vertical direction; wherein
a cutout is formed in a joint between the tail section and the retention section so as not to have forces applied on the tail section influence the contacting section.

9. The electrical connector assembly as claimed in claim 8, further including a second set of contacts disposed in the corresponding passageways and alternately arranged with the set of contacts in the transverse direction, wherein said second set of contacts define corresponding retention sections and contacting sections similar to those of the first set of contacts while having corresponding tail sections staggered with those of the set of contacts in the first vertical direction so as to form corresponding mating faces facing in the first vertical direction opposite to those of the first set of contacts.

10. The electrical connector assembly as claimed in claim 9, further including a metallic shell enclosing the base portion and the tongue portion.

11. The electrical connector assembly as claimed in claim 9, wherein a printed circuit board is disposed behind the tongue portion, on which the board mounting faces are seated.

12. The electrical connector assembly as claimed in claim 9, wherein said cutout faces toward an exterior in the first vertical direction.

13. The electrical connector assembly as claimed in claim 9, wherein in each of the second set of contacts, a cutout is formed a joined section between the corresponding retention section and the corresponding tail section under condition that said cutout faces toward an exterior in the second vertical direction.
